(19) United States
(12) Patent Application Publication
(10) Pub. No.: US 2014/0376248 A1
(43) Pub. Date: Dec. 25, 2014

(54) LED LIGHTING DEVICE AND VEHICLE HEADLIGHT HAVING SAME

(71) Applicant: Icepipe Corporation, Seoul (KR)

(72) Inventor: Sang-Cheol Lee, Gyeonggi-do (KR)

(21) Appl. No.: 14/480,982

(22) Filed: Sep. 9, 2014

Related U.S. Application Data
(63) Continuation of application No. PCT/KR12/01773, filed on Mar. 12, 2012.

(51) Int. Cl. F21S 8/10

(52) U.S. Cl. CPC F21S 48/115; F21S 48/32; F21S 48/1241; F21Y 2101/02
USPC 362/511

(57) ABSTRACT

An LED lighting device includes an LED module; a light guide member disposed adjacent to the LED module guides light emitted from the LED module towards an object; a heat transfer member coupled to the LED module absorbs the heat from the LED module; a heat-absorbing portion is formed in the shape of a capillary tube, injected with working fluid, and coupled to the heat transfer member so as to absorb heat; and a heat pipe loop provided with a heat-dissipating portion for dissipating the heat absorbed in the heat-absorbing portion. The LED lighting device can have a simple structure without a cooling fan while obtaining a high output by including the heat-dissipating portion which has a large dissipation area and high heat transfer performance. Since heat dissipation can be carried out without an additional cooling device, minor failures can be reduced, and maintenance of the device can be simplified.

### CROSS REFERENCE TO RELATED APPLICATIONS

This application is a continuation of PCT/KR2012/001773 filed Mar. 12, 2012, the disclosure of which is incorporated herein by reference in its entirety.

### BACKGROUND

1. Technical Field

The present relates to an LED lighting device and a vehicle headlight having the same.

2. Background Art

An LED lighting device utilizing LED has a large amount of heat generated due to heat generated by the LED. Generally, when an electronic device is overheated, the electronic device may malfunction or be damaged, and thus it is essentially required to equip the LED lighting device with a heat-dissipating structure in order to prevent the overheating.

Particularly, since a vehicle headlight using an LED utilizes a high-output LED and generates a very large amount of heat, heat dissipation for preventing overheating becomes a very important factor.

Disclosed previously as a heat-dissipating device used for the headlight using LED has been a heat-dissipating device having heat-dissipating fins.

However, it is difficult for the heat-dissipating fin structure of heat-dissipating device to keep the surface areas of the heat-dissipating fins large enough when the size of a heat-absorption portion needs to be small due to the small size of an LED module. Moreover, even if the surface areas of the heat-dissipating fins are enlarged, there is quite a distance between the heat-absorption portion and a heat-dissipating portion, slowing the speed of heat transfer and keeping the heat-dissipating efficiency from improving.

Accordingly, additionally installing a cooling fan has been suggested to address the limitations of the conventional heat-dissipating fin structure of heat-dissipating device, but the structure thereof has become complicated due to the installation of the cooling fan, resulting in frequent malfunction and increased manufacturing costs.

### SUMMARY

### Technical Problem

The present invention provides an LED lighting device that has good heat transfer properties, a high heat-dissipating efficiency and a simple structure, and a vehicle headlight having the same.

Moreover, the present invention provides an LED lighting device that has little malfunction and is easy to maintain, and a vehicle headlight having the same.

### Technical Solution

An aspect of the present invention provides an LED lighting device, which includes: an LED module; a light guide member arranged adjacently to the LED module and configured to guide light emitted by the LED module to a target object; a heat transfer member coupled to the LED module and configured to absorb heat from the LED module; and a heat pipe loop formed in the shape of a capillary tube and comprising a heat-absorbing portion coupled to the heat transfer member to absorb heat and a heat-dissipating portion configured to dissipate the heat absorbed by the heat-absorbing portion.

The heat transfer member can include a wick type of heat transfer pipe having a wick formed on an inner wall thereof and having working fluid injected thereinto.

The heat transfer pipe can be curved in such a way that two end portions thereof face each other, and the two end portions of the heat transfer pipe facing each other can have have the heat pipe loop wound thereon and coupled thereto.

The heat transfer member can further include a heat transfer block coupled with the LED module and the heat transfer pipe and can be configured to transfer the heat generated by the LED module to the heat transfer pipe.

The heat transfer member can include a thermal base coupled to the LED module and the heat pipe loop so as to support the LED module and the heat pipe loop and configured to transfer the heat generated by the LED module to the heat pipe loop.

The thermal base can have a heat transfer groove in the shape of a trench, and the heat pipe loop can be formed in a spiral structure in which the heat-absorbing portion and the heat-dissipating portion are repeatedly formed, and the heat-absorbing portion can be inserted into and coupled to the trench shape of heat transfer groove.

The heat pipe loop can be radially arranged along an edge region of the thermal base.

Another aspect of the present invention provides a vehicle headlight including the LED lighting device described above.

### BRIEF DESCRIPTION OF THE DRAWINGS

FIG. 1 is a perspective view showing an LED lighting device in accordance with an embodiment of the present invention.

FIG. 2 is an exploded perspective view showing the LED lighting device in accordance with an embodiment of the present invention.

FIG. 3 is a top view showing the LED lighting device in accordance with an embodiment of the present invention.

FIG. 4 is a side view showing the LED lighting device in accordance with an embodiment of the present invention.

FIG. 5 is a perspective view showing a heat pipe loop of the LED lighting device in accordance with an embodiment of the present invention.

FIG. 6 is a perspective view showing an LED lighting device in accordance with another embodiment of the present invention.

FIG. 7 is an exploded perspective view showing the LED lighting device in accordance with another embodiment of the present invention.

FIG. 8 is a top view showing the LED lighting device in accordance with another embodiment of the present invention.

### DETAILED DESCRIPTION

Hereinafter, an embodiment of the present invention will be described with reference to the accompanying drawings.

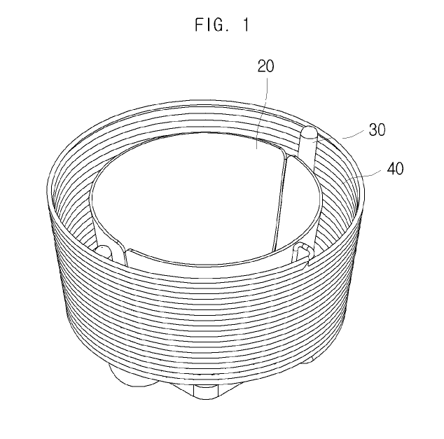

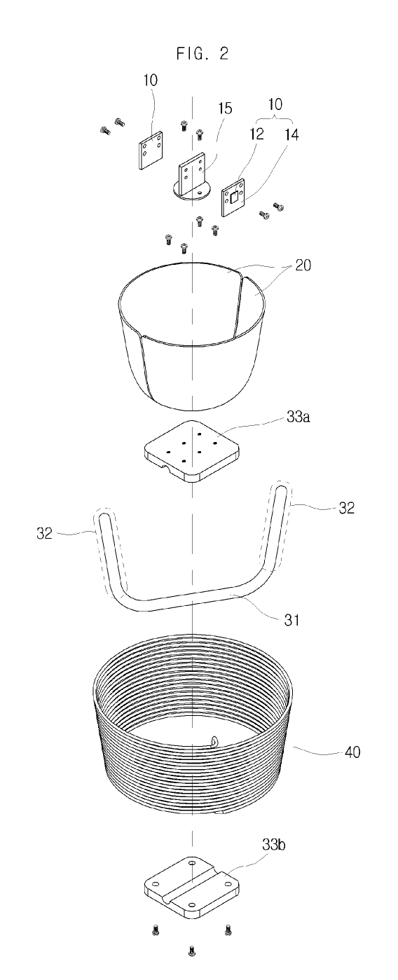

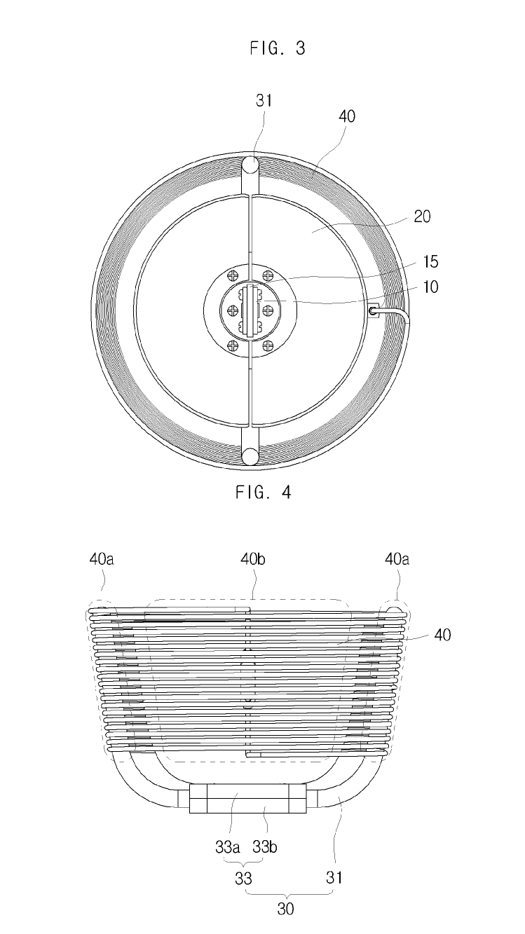

FIG. 1 is a perspective view showing an LED lighting device in accordance with an embodiment of the present invention, and FIG. 2 is an exploded perspective view showing the LED lighting device in accordance with an embodiment of the present invention, FIG. 3 is a top view showing the LED lighting device in accordance with an embodiment of the present invention.

The LED lighting device in accordance with an embodiment of the present invention includes an LED module 10, a reflective mirror 20, a heat transfer member 30 and a heat pipe loop 40.

The LED module 10 encompasses an LED 12 that can emit light by using electric energy to generate light required for lighting.

As shown in FIG. 2 and FIG. 3, the LED module 10 of the present embodiment is constituted with the LED 12 and a module substrate 14 to which the LED 12 is mounted, and the LED module 10 is positioned to be supported by a support member 15 so as to be oriented toward the reflective mirror 20.

Moreover, a high output LED 12 is used in the present embodiment in order for the LED lighting device to be used as a vehicle headlight.

A light guide member 20 is configured to guide light so that the light emitted by the LED module 10 is oriented toward a target object. For this, the light guide member 20 is arranged adjacent to the LED module 10 so as to receive the light emitted by the LED module 10.

In the present invention a reflective mirror is used as the light guide member 20. Specifically, the reflective mirror is arranged to surround the LED module 10 so as to reflect the light emitted by the LED module 10 toward the target object.

As illustrated in FIG. 2 and FIG. 3, the reflective mirror of the present embodiment forms lighting required for the vehicle headlight, which projects light forwardly, by receiving the light emitted by the LED 12 at a concave surface thereof and transforming the received light to a bundle of parallel light.

Although the reflective mirror is presented as the light guide member 20 in the present embodiment, the light guide member 20 is not limited to what is described herein, and a variety of optical means, for example, a lens, can be used as the light guide member 20 as long as light can be refracted or reflected to have a path thereof adjusted.

The heat transfer member 30 is coupled with the LED module 10 directly or indirectly to absorb heat irradiated by the LED module 10 and transfer the absorbed heat to the heat pipe loop 40.

Particularly, the heat transfer member 30 of the present embodiment includes a wick type of heat transfer pipe 31 that is arranged adjacent to the LED module 10 so as to transfer a large amount of heat generated by the LED module 10 to a heat-dissipating portion 40b quickly.

The wick type of heat transfer pipe 31 is constituted with a sealed pipe, into which working fluid is injected, a wick, through which the working fluid moves, formed on an inner wall of the pipe, and a vapor moving space, in which vaporized working fluid moves within the pipe. In describing the functions specifically, the working fluid vaporized at which the heat is transferred moves through the vapor moving space to a heat transfer portion 32, which transfers the heat to an outside. Then, the vaporized working fluid that has moved to the heat transfer portion 32 becomes condensed and transfers evaporation heat to the heat transfer portion 32. The condensed working fluid flows back to an original position through the wick. Accordingly, a heat-transfer cycle of transferring the heat to the heat transfer portion 32 is completed.

The wick type of heat transfer pipe 31 having the above-described heat-transfer structure has a relatively larger diameter of tube than the heat pipe loop 40 and can have a large quantity of working fluid injected thereinto. Accordingly, a large amount of heat can be quickly transferred to the heat transfer portion 32 through a process of vaporizing and condensing a large amount of working fluid at once. As a result, the heat can be quickly transferred to the heat pipe loop 40 so as not to allow the heat generated by the LED module 10 to be accumulated, thereby increasing the heat dissipating efficiency

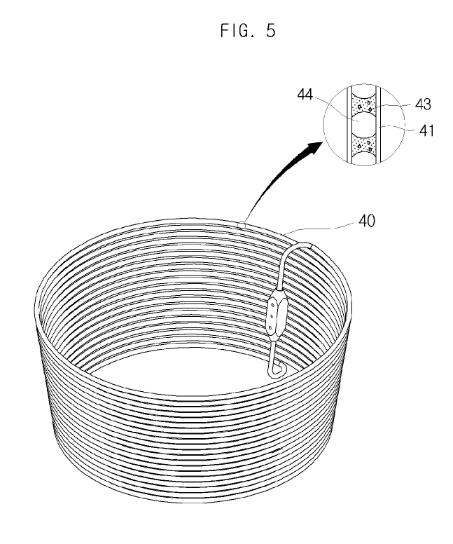

FIG. 4 is a side view showing the LED lighting device in accordance with an embodiment of the present invention.

As illustrated in FIG. 2 to FIG. 4, the heat transfer pipe 31 of the present embodiment is curved (for example, in the shape of “U”) so that two end portions thereof face each other. Moreover, the two end portions of the heat transfer pipe 31 facing each other have the heat pipe loop 40 wound thereon and coupled thereto. Accordingly, the two end portions of the heat transfer pipe 31 can become the heat transfer portion 32 to transfer the heat to the heat pipe loop 40.

Moreover, the heat transfer pipe 31 of the present embodiment can be coupled to the LED module 10 via a heat transfer block 33 to absorb the heat generated by the LED module 10. For example, the heat transfer pipe 31 can be inserted in between the heat transfer block 33, which is constituted with an upper block 33a and a lower block 33b, and the LED module 10 can be coupled to the upper block 33a so as to allow the LED module 10 and the heat transfer pipe 31 to transfer the heat. Here, the heat transfer block 33 can be made of a material having a high thermal transfer property, for example, copper, aluminum, etc. Moreover, the reflective mirror can be assembled with and supported by the heat transfer block 33.

Meanwhile, other than indirectly being coupled to the LED module 33 via the heat transfer block 33, it is possible that the heat transfer pipe 31 is directly coupled, for example, soldered, to the LED module 10.

The heat pipe loop 40 is a portion that is coupled to the heat transfer member 30 to absorb heat and dissipate the absorbed heat to an outside. Particularly, in the present embodiment, a vibrating capillary type of heat pipe loop 40 in order to dissipate a large amount of heat quickly.

FIG. 5 is a perspective view showing the heat pipe loop of the LED lighting device in accordance with an embodiment of the present invention.

As shown in FIG. 4 and FIG. 5, the heat pipe loop 40 includes a heat-absorbing portion 40a and a heat-dissipating portion 40b, and working fluid 43 is injected into the heat-dissipating portion 40b together with air bubbles 44. The heat-absorbing portion 40a is coupled to the heat transfer pipe 31, which transfers heat, to absorb the heat. The heat-dissipating portion 40b is separated from the heat transfer pipe 31 and is communicated with the heat-absorbing portion 40a to dissipate the heat transferred from the heat-absorbing portion 40a.

Particularly, the heat-pipe loop 40 of the present embodiment is constituted with a vibrating capillary type of heat pipe using hydrodynamics.

The vibrating capillary type of heat pipe has a structure in which the working fluid 43 and the air bubbles 44 are injected into a capillary tube 41 in a predetermined ratio and then an inside of the capillary tube 41 is sealed from an outside. Accordingly, the vibrating capillary type of heat pipe has a heat-transfer cycle in which the heat is mass transported in the form of latent heat by volume expansion and condensation of the air bubbles 44 and the working fluid 43.

In a heat-transfer mechanism, as nucleate boiling occurs in the heat-absorbing portion 40a by as much as the absorbed amount of heat, volume expansion occurs in the air bubbles 44 located in the heat-absorbing portion 40a. Here, since the capillary tube 41 maintains a fixed internal volume, the air bubbles 44 located in the heat-dissipating portion 40b condense by as much as the expanded volume of the air bubbles 44 located in the heat-absorbing portion 40a. Accordingly, the state of pressure equilibrium in the capillary tube 41 becomes broken, resulting in a flow accompanied with vibrations of the working fluid 43 and the air bubbles 44 within the capillary tube 41, and thus heat dissipation is carried out as the latent heat is transported by the rise and fall of the temperature caused by the volume change of the air bubbles 44.

Here, the heat-pipe loops 40 can include the capillary tube 41 that is made of highly thermal-conductive metallic materials, such as copper, aluminum, etc. Accordingly, not only can the heat be conducted quickly, but the volume change of the air bubbles 44 injected therein can be quickly induced.

Both an open loop and a close loop are possible for a communication structure of the heat pipe loop 40. Moreover, if the heat pipe loop 40 provided in plurality, all or some of the plurality of heat pipe loops 40 can be communicated with a neighboring heat pipe loop 40. Accordingly, the plurality of heat pipe loops 40 can have an entirely open or close loop shape according to design requirement.

Here, as shown in FIG. 4, the heat pipe loop 40 of the present embodiment can be formed in a spiral structure wound on the two end portions of the heat transfer pipe 31. Moreover, the capillary tube 41 forming the heat pipe loop 40 can be formed to have a smaller diameter than that of the heat transfer pipe 31. Accordingly, the capillary tube 41 constituting the heat pipe loop 40 can be coupled to the heat transfer portion 32 of the heat transfer pipe 31 at several locations. Therefore, an area of the heat-absorbing portion 40a of the heat pipe loop 40 is significantly increased, allowing the heat pipe loop 40 to efficiently absorb a large amount of heat transferred through the heat transfer pipe 31.

Then, in the spiral shape of the heat pipe loop 40, the capillary tube 41, provided in plurality and arranged in parallel with one another in between the heat transfer pipe 31, becomes the heat-dissipating portion 40b. Accordingly, an area of the heat-dissipating portion 40b of the heat pipe loop 40 is greatly increased, making it possible to dissipate the heat inside the heat pipe loop 40 efficiently.

Therefore, by configuring a heat dissipating device having a large heat dissipation area and high heat transfer performance, it becomes possible to configure the LED light device having a simple structure without a cooling fan while having a high output. Accordingly, the LED lighting device can perform heat dissipation without an additional cooling device, for example, a cooling fan, allowing it for malfunction-free operation and easy maintenance.

Hereinafter, an LED lighting device in accordance with another embodiment will be described.

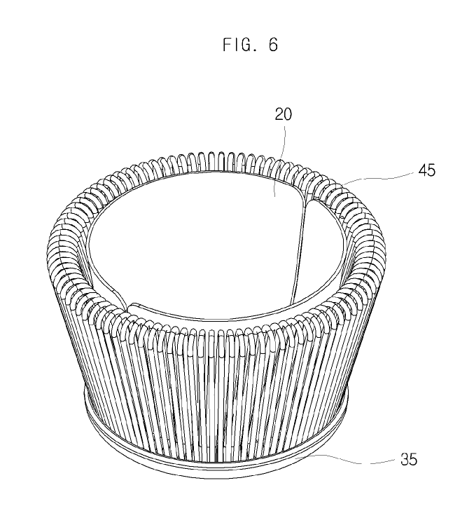

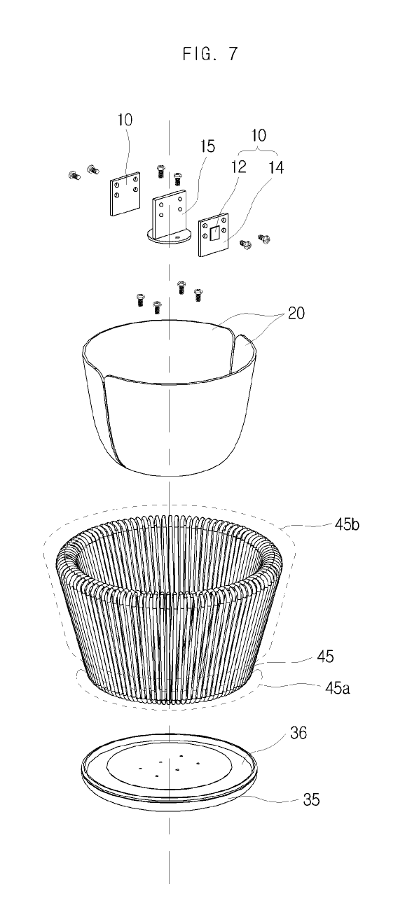

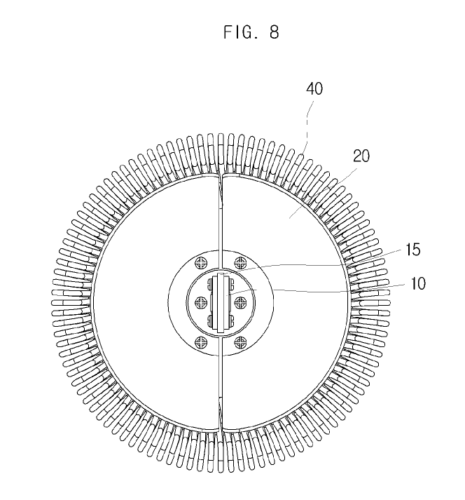

FIG. 6 is a perspective view showing an LED lighting device in accordance with another embodiment of the present invention. FIG. 7 is an exploded perspective view showing the LED lighting device in accordance with another embodiment of the present invention, and FIG. 8 is a top view showing the LED lighting device in accordance with another embodiment of the present invention.

The LED lighting device in accordance with the present embodiment is different from the earlier-described embodiment in that a thermal base 35, which supports an LED module 10 and a heat pipe loop 45, is used as a heat transfer member.

The thermal base 35, which is a portion that receives heat generated by the LED module 10 and transfers the heat to the heat pipe loop 45, also functions to support the LED module 10 and the heat pipe loop 45. For this, the thermal base 35 is coupled with the LED module 10 and the heat pipe loop 45 in such a way that heat transfer is possible.

Particularly, the thermal base 35 of the present embodiment is formed with a heat transfer groove 36, having the heat pipe loop 45 inserted therein and coupled thereto. Here, the heat transfer groove 36 is formed in the shape of a trench in such a way that the heat pipe loop 45 can be easily inserted therein and stably supported thereby. Moreover, by filling solder or the like in the heat transfer groove 36 after inserting the heat pipe loop 45, the heat pipe loop 45 can be readily coupled to the thermal base 35.

As shown in FIG. 6 and FIG. 7, the thermal base 35 of the present embodiment is formed in the shape of a disk, and the heat transfer groove 36 in an annular shape is formed along an edge region of the thermal base 35. Accordingly, the heat pipe loop 45 inserted in the heat transfer groove 36 is arranged in the form of a cylinder, making it possible to provide a large surface area. Moreover, the cylindrical shape of heat pipe loop 45 has a radial structure that is advantageous for dissipating heat of the thermal base 35 and a heat source disposed inside the heat pipe loop 45.

Here, the heat pipe loop 45 is formed in a spiral structure, in which a heat-absorbing portion 45a and a heat-dissipating portion 45b are repeatedly formed, and the repeatedly-formed heat-absorbing portion 45a is successively inserted into and coupled to the trench shape of heat transfer groove 36.

Meanwhile, the arrangement of the heat transfer groove 36 and the heat pipe loop 45 is not restricted to what is described herein, and there can be a variety of arrangement, for example, a polygonal structure of heat transfer groove 36 or a pattern of a plurality of heat transfer grooves 36.

While the present invention has been described with reference to certain embodiments, the embodiments are for illustrative purposes only and shall not limit the invention. It is to be appreciated that those skilled in the art can change or modify the embodiments without departing from the scope and spirit of the invention.

It shall be also appreciated that a very large number of embodiments other than those described herein are possible within the scope of the present invention, which shall be defined by the claims appended below.

### INDUSTRIAL APPLICABILITY

According to the present invention, it is possible to provide an LED lighting device having a simple structure without utilizing a cooling fan whilst having a high output by configuring a heat dissipating device having a large heat dissipation area and high heat transfer performance.

Moreover, by providing an LED light device that can carry out heat dissipation without an additional cooling device such as a cooling fan, maintenance can be easier, without malfunction.

What is claimed is:

1. An LED lighting device comprising:
an LED module;
a light guide member arranged adjacently to the LED module and configured to guide light emitted by the LED module to a target object;
a heat transfer member coupled to the LED module and configured to absorb heat from the LED module; and
a heat pipe loop formed in the shape of a capillary tube and comprising a heat-absorbing portion coupled to the heat transfer member to absorb heat and a heat-dissipating portion configured to dissipate the heat absorbed by the heat-absorbing portion.

2. The LED lighting device of claim 1, wherein the heat transfer member comprises a wick type of heat transfer pipe having a wick formed on an inner wall thereof and having working fluid injected thereinto.

3. The LED lighting device of claim 2, wherein the heat transfer pipe is curved in such a way that two end portions thereof face each other, and
wherein the two end portions of the heat transfer pipe facing each other have the heat pipe loop wound thereon and coupled thereto.

4. The LED lighting device of claim 2, wherein the heat transfer member further comprises a heat transfer block coupled with the LED module and the heat transfer pipe and configured to transfer the heat generated by the LED module to the heat transfer pipe.

5. The LED lighting device of claim 1, wherein the heat transfer member comprises a thermal base coupled to the LED module and the heat pipe loop so as to support the LED module and the heat pipe loop and configured to transfer the heat generated by the LED module to the heat pipe loop.

6. The LED lighting device of claim 5, wherein the thermal base has a heat transfer groove in the shape of a trench, and
wherein the heat pipe loop is formed in a spiral structure in which the heat-absorbing portion and the heat-dissipating portion are repeatedly formed, and the heat-absorbing portion is inserted into and coupled to the trench shape of heat transfer groove.

7. The LED lighting device of claim 5, wherein the heat pipe loop is radially arranged along an edge region of the thermal base.

8. A vehicle headlight comprising the LED lighting device of claim 1.

9. A vehicle headlight comprising the LED lighting device of claim 2.

10. A vehicle headlight comprising the LED lighting device of claim 3.

11. A vehicle headlight comprising the LED lighting device of claim 4.

12. A vehicle headlight comprising the LED lighting device of claim 5.

13. A vehicle headlight comprising the LED lighting device of claim 6.

14. A vehicle headlight comprising the LED lighting device of claim 7.
